(19) United States
(12) Patent Application Publication
(10) Pub. No.: US 2008/0065600 A1
(43) Pub. Date: Mar. 13, 2008

(54) Method and apparatus for providing search results from content on a computer network

(76) Inventors: Harold Batteram, Kortenhst (NL); Jacco Brok, Enschede (NL); Ronald van Haalen, Nijmegen (NL); Harold Teunissen, Deventer (NL)

Correspondence Address: Lucent Technologies Inc.;Docket Administrator - Room 3J-219, 101 Crawfords Corner Road, Holmdel, NJ, 07733-3030, US

(21) Appl. No.: 11/519,716

(22) Filed: Sep. 12, 2006

(51) Int. Cl. G06F 17/30

(52) U.S. Cl. 707/3

(57) ABSTRACT

A user enters a search query at interface 1 for performing a search on a computer network, such as the Internet. The search results are enhanced by adjusting their weightings to take into account previous searches carried out by members of a group, the membership of which is selected by the user. The group may be a user-defined co-user list, for example. Those previous search results that were of interest to members of the group are thus given greater prominence in the search results presented to the user at display 8. The user's behavior in considering the search results is monitored and the information gained used to update a database 5 holding group search information.

### FIELD OF THE INVENTION

The present invention relates to a method of providing search results from content on a computer network, and apparatus for providing such search results. The invention is particularly, but not exclusively, concerned with searching for documents on the Internet.

### BACKGROUND OF THE INVENTION

The vast number of documents available via accessing the Internet makes it difficult for users to find those that are most relevant to their needs. The World Wide Web, a subset of the Internet, includes millions of WebPages which tend to be insufficiently indexed. Even large intranets or extranets, belonging to corporate or government entities, for example, can be difficult to navigate. Often, a user will turn to a search engine when seeking particular information or documents. Search engines use different methods to find content based on a user's query. For example, they may index content using keywords to create a searchable database, or order documents in categories. Algorithms may be used to apply weightings to the results of the searches to rank them, so that those documents deemed most likely to be important are presented first to the user. Greater importance may, for example, be attributed to a page having a large number of other pages linking to or from it, or to one which includes a lager number of keywords, or to longer documents, and so on.

Search results may be enhanced by building an individual profile of a user, for example, by monitoring the user's past behavior in connection with previous search results. The profile may be used to rank the search results so as to give greater prominence to those results that are similar to pages which have already been indicated to be of interest, for example, by the user having spent a longer time at a certain previous page than at other pages also listed in the previous search results.

Another method, offered by Eurekster, takes into account the results of previous searches performed by members of an online community, such as a social networking site. The search behavior of the members of the community is used to identify search terms based on what users most frequently search for on the community website. As the number of submitted search queries grows, the search results become more focused as the search terms become further defined.

### BRIEF SUMMARY OF THE INVENTION

In one aspect, the invention relates to a method of providing search results from content on a computer network. The content may be WebPages, hyperlinks, text, images, videos or any other form of content that is searchable. The invention is applicable to content held on the Internet, World Wide Web, extranets, intranets or any other type of network giving access to searchable content.

A user submits a query, and a search is performed on the query to generate ranked search results. A group of individuals which the user has chosen to include in a user-defined list is identified. When ranking the search results, group search information connected with previous searches carried out by members of the group is consulted. The group may comprise the user and others belonging to a user-defined online co-user list, such as the application provided by America Online, Inc under the registered trade mark “Buddy List”. These types of lists are used, for example, on computers, cellular telephones and/or similar devices to allow a user to keep track of certain people. They enable, for example, a user to see whom from their list is online, offline, on the telephone and which are available for instant messaging or chat. Often, a user will know people on such a list in real life, for example, they may be family members, friends or colleagues. In any case, typically, individuals included on a user-defined list trust one another. Group search information from these trusted people is used, and this tends to be more valuable in providing enhanced search results for a user than information from random unknown people, even where the unknown people are members of a community to which the user belongs.

As the user has deliberately chosen to add individuals to the list, it is likely that he or she will have a fairly close connection with the members of the group. Thus, previous search results which have been of interest to other members of the group may be deemed to be of more value to the user than content that other members of the group have found to be not of interest when previously presented to them. This can be used to enhance the search results for a user, making use not only of the user's own previous behavior but also that of a larger related group, giving greater scope and efficiency in building a profile. Advertisements that are selected for display to the user based on the search results are thus also likely to be better targeted at the user, benefiting both the user and the advertiser. Also, different people tend to favor different search applications for retrieving documents from a computer network. As search applications use diverse strategies for performing a search, one search application may rank a particular document more prominently than another. Thus it may be more immediately accessible using one search application than another one. If such a document has been found in a previous search and considered valuable by a member of the group, it can accordingly be ranked higher than would otherwise be the case with the search application selected by the user and thus made accessible to that user. Alternatively, the invention may be implemented so that it is used with the same search application each time, thus enhancing search results retrieved using that search application compared to other search applications.

The group search information may include information about the behavior of members of the group connected with search results of previous searches. By taking into account the behavior of the group members on similar searches—for example, how a search query was refined on several iterations, which links were skipped, which links were followed, after how much time did the member return to the search page again to find another link or other types of behavior metrics—the more promising results for this group may be displayed more prominently in the search results for the user's query, and the less relevant ones less prominently. This may be implemented by ranking search results using weightings derived from the group search information.

In one method of the invention, the search is performed to generate initial ranked search results, and then the search results are re-ranked using weightings derived from the group search information. Both the ranked and re-ranked search results may be available to the user. For example, a link to each set of search results may be presented to the user who can then decided to look at either or both sets of results. Alternatively, only the search results which have been adjusted to take into account the group search information may be made available to the user. In another method in accordance with the invention, the search is performed to generate initial ranked search results, the results being ranked using an algorithm which includes the use of weightings derived from the group search information. The group search information is used to provide initial ranked search results instead of being applied in a separate step after the initial results have been generated.

A method in accordance with the invention may further include collecting information about the behavior of the user in connection with the search results and using the information to update the group search information. This builds the group search information. The group search information may represent a combination of search information of the individuals. Alternatively, or in addition, it may comprise a set of individual search information data. The group search information may be held as already weighted information. In another method, the group search information may include the necessary data to apply weighting after it has been accessed for consultation.

In another method in accordance with the invention, in addition to the group of individuals selected by the user to be included in a user-defined list, group search information from another additional group may also be used to further enhance the search results. The additional group may be an online community to which the user belongs, for example, a community of a type whose members have a common interest. By joining the community, a user is likely to share a similar interest or interests with its other members. The additional group may consist of all of the members of the community or a subset thereof. The community may be a networking site in which a user may designate other participants as “friends”, or some other term, to allow them to have access to content posted by the user. In this example, the group may consist of the user and individuals designated “friends” by the user. Group search information from such a group may tend to be more valuable in providing enhanced search results for a user than information from random unknown people with which the user has no connection.

In another method in accordance with the invention, the further steps are included of: identifying a plurality of groups of individuals with which the user has chosen to associate; and consulting the group search information of the plurality of groups when ranking the search results. At least one of the plurality of groups may comprise the user and others belonging to a user-defined online co-user list, and in addition, or alternately, at least one of the plurality of groups may be an online community. By using group search information from more than one group, additional information is available for consultation in ranking the search results. Group search information from one or more groups may be considered as more valuable than that from others, and the information derived therefrom given greater weight accordingly when ranking the results. For example, a group comprising the user and a user-defined list may be considered to be of greater relevance than a group consisting of a sub-set of a social networking community. Alternatively, or in addition, group search information from a first group comprising one user-defined list may be deemed more valuable than that from a second group comprising another user-defined list. For example, where the user has more frequent contact, say, via instant messaging or email, with members of the first group than the second group, group search information from the first group may be accorded greater influence in ranking the search results.

In another method in accordance with the invention, the steps are included of: identifying at least one related group which does not include the user and which does include an individual who is a member of the group of individuals which said user has chosen to include in the user-defined list; and consulting the group search information of the at least one related group when ranking the search results. This permits the amount of group search information available for consultation to be increased beyond that group or groups that the user has chosen to join, but it still retains a connection with the user due to the individual who belongs to the user's group and also to the related group. Weightings used in ranking the search results may give more significance to the group search information of the group with which the user has chosen to associate than the at least one related group. This reflects the less direct connection to the user. The group that the user has chosen to associate with and the related group may be groups of the same category, for example, both user-defined lists, or they may be different types of group.

According to another aspect of the invention, an apparatus for providing search results from content on a computer network, comprises: a search application for generating search results in response to a user query; a store listing a group of individuals including the user, the individuals having been chosen by the user to be included in the group; a database holding group search information connected with previous searches carried out by members of the group; and ranking means operative to receive the group search information from the database and to rank the search results by applying weightings derived from the information. Means may be included for collecting information concerning user behavior in connection with the search results and for updating the database using the information.

### BRIEF DESCRIPTION OF THE DRAWINGS

Some embodiments and methods in accordance with the present invention will now be described by way of example only, and with reference to the accompanying drawings, in which:

FIG. 1 schematically illustrates a method in accordance with the invention;

FIG. 2 schematically illustrates an apparatus in accordance with the invention which uses group search information from a plurality of groups; and

FIG. 3 schematically illustrates an apparatus similar to that shown in FIG. 2, with like references being used for like parts, in which only one group search information database is included.

### DETAILED DESCRIPTION

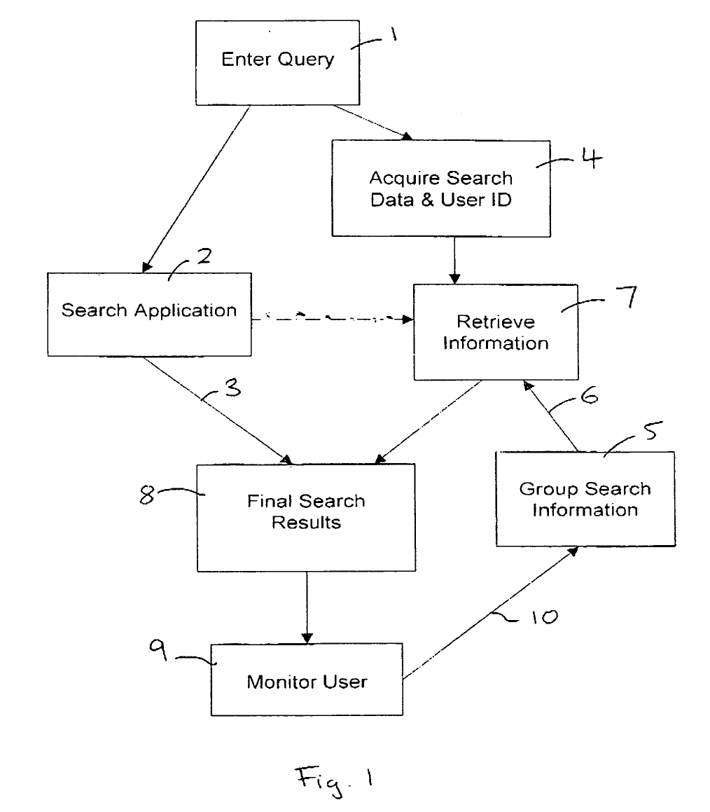

With reference to the method illustrated in FIG. 1, a user enters a search query 1 at an Internet search interface to perform a search relating to a set of keywords that the user thinks will lead to documents of interest. The search is carried out at step 2 by a search application that the user has selected, for example, Google or Yahoo, and this generates initial search results 3 which are ranked in a way that depends on the algorithms used by that search application to determine the relevance of retrieved documents.

In parallel with this procedure, search data is acquired at 4, using the search query from 1 to identify the search and searches similar to it, and also the identity of the requesting user, and thus the identity of a group associated with that user. The membership of the group has been defined by the user, and in this example is a user-defined online co-user list. Then group search information 5 related to that group is accessed via path 6 to retrieve information on similar previous searches carried out by members of the group. The retrieved information 7 includes an indication of the relevance of documents retrieved in previous similar searches to members of the group, determined, for example, by the behavior of members of the group connected with previous search results. The retrieved group search information 7 and initial search results 3 are used to generate final search results at 8. The retrieved group search information 7 is consulted at 8 to determine what weightings should be applied to certain documents or categories of documents based on their importance to members of the group in connection with previous searches. These weightings are applied to the initial search results to re-rank them and generate final search results at 8.

The behavior of the user is monitored as he or she acts on the search results. Information such as the category, or categories, of documents selected by the user to consider, document identity, address, time spent at a certain pages or links followed, is collected at 9 and then forwarded via path 10 to be included in the group search information 5, together with the search query. The information is combined with the other information already held so that it is not identifiable as having come from a particular user. However, in other methods in accordance with the invention, the information is arranged in a way that it is possible if desired to determine with which member of the group the information is associated.

In an alternative method, the search query terms used at 4 are acquired from the search application 2, indicated by a broken line in FIG. 1, as this enables expansions and alternatives of those terms which may be implemented by the search application in performing the search to also be used in retrieving information from the group search information.

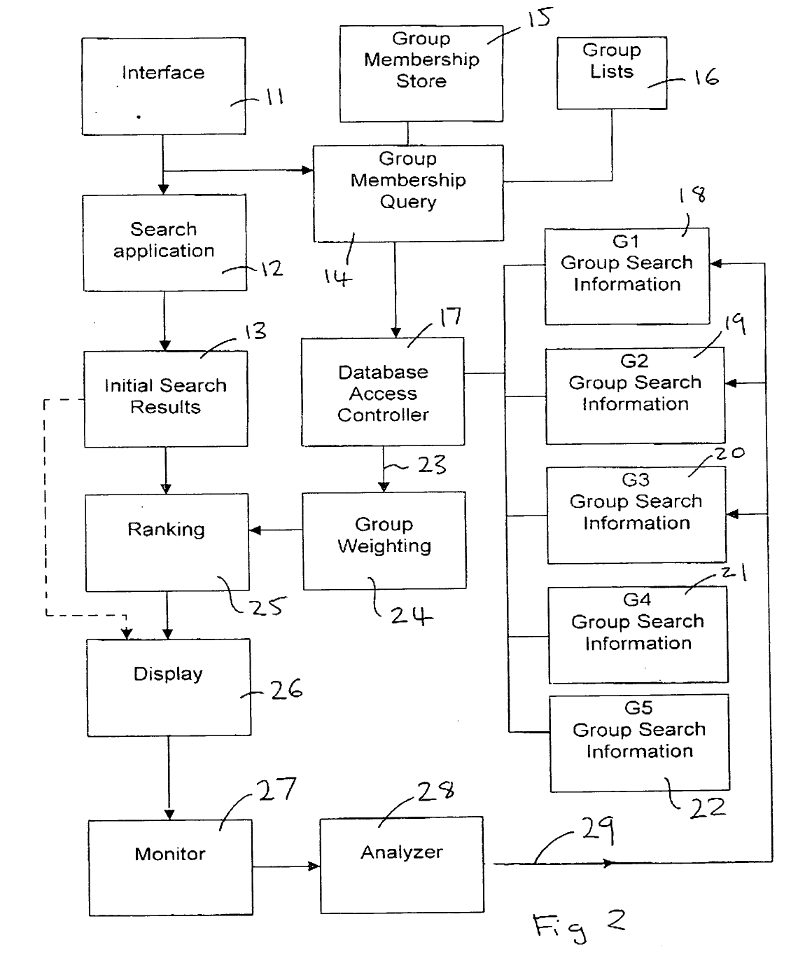

With reference to FIG. 2, a user enters a search query at an Internet interface 11 from which the query is applied to a search application 12. The search application 12 performs a search on the query and generates initial search results which are ranked according to rules implemented by the search application 12 such that those results likely to be more relevant are ordered in a more prominent position than others. The initial search results are stored in a store 13.

When the user enters the search query at interface 11, he or she also causes an instruction to be sent to a processor 14 to check that user's group membership by accessing a group membership store 15. This store 15 holds data which identifies those user-defined co-user lists that are associated with that user, any online communities that the user has joined and memberships of any other types of group which might be available for the user to choose to join. The identities of those groups to which the user belongs are then transmitted to the processor 14. In this example, the user is determined to belong to an online community group G1, and two user-defined co-user lists, groups G2 and G3, the members of groups G2 and G3 having been previously defined by the user making a positive choice to add certain individuals to the lists. Having acquired data concerning which groups the user has joined, the processor 14 then interrogates a table 16 holding lists of groups and their members to identify a group or group that has a member who belongs to group G2 or G3 and also to another user-defined co-user list to which the user initiating the search query does not belong. This is used to identify groups G4 and G5 that are related to the groups G2 and G3 that the user belongs to but to which the user does not him- or her-self belong. The number of related groups retrieved may be limited by processor 14 so as to ensure that a maximum number of groups and related groups are under consideration, to avoid overload.

The identities of groups G1, G2 and G3, and related groups G4 and G5, are transmitted to a database access controller 17, which also receives search query data from the search application 12. The controller 17 accesses group search information databases 18, 19, 20, 21 and 22, each of which is associated with a respective one of groups G1 to G5, using the search query data to retrieve group search information relevant to the particular query that the user has made. The group search information is information concerning previous searches made by members of that group, including the relative usefulness of previous search results to those members. The group search information is applied on line 23 to group weighting unit 24, which adjusts the group search information such that that originating from members of user-defined co-user lists G2 and G3 is weighted to have more influence than that from members of online community group G1, and that of related groups G4 and G5 is given the least significance.

The group-weighted output is then applied to ranking unit 25 which uses the indication of relative importance to members of the groups represented by the output to adjust weightings of the initial search results to re-rank them into an order which reflects that relative importance. The final search results so obtained are then presented to the user who made the query at display 26. The behavior of the user as he or she considers the results is monitored at 27 and applied to analyzer 28 to rate the search results in terms of usefulness to that user as evinced by the user's behavior. The results of the analysis and the search query that led to the search results are then transmitted on line 29 to the group search information databases 18, 19 and 20 that are associated with the groups G1, G2 and G3 to which the user belongs. This data is used to update the databases 18, 19 and 20 so that it is available for later searches involving any of these groups.

In an alternative arrangement, as indicated by broken line 30, an option is given to the user to access the initial search results stored in store 13 in addition to the enhanced results obtained by using weightings derived from the group search information. The user's behavior in assessing the two sets of results is monitored at 27 and data representative of that behavior is transmitted to the analyzer 28 to provide additional input information for analysis.

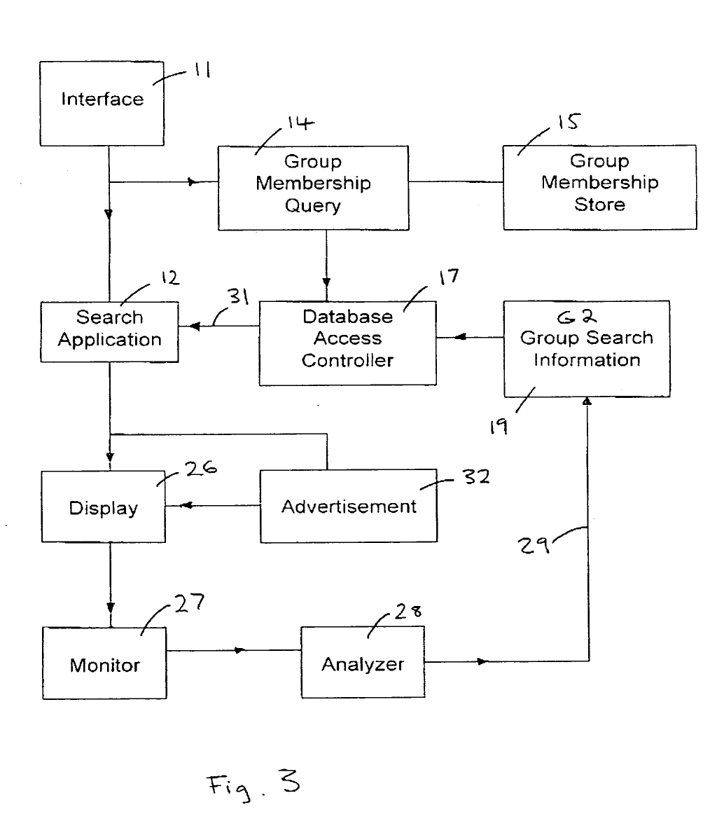

With reference to FIG. 3, in another apparatus in accordance with the invention, only one group search information database 19 is included, this storing information related to searches carried out by members of a user-defined co-user list G2 maintained by the user who has made a search query. In this embodiment, the information derived from the group search information database is applied on line 31 to the search application 12, which uses it to adjust weightings applied by its algorithm to generate search results for presentation at display 26 for consideration by the user. An advertisement unit 32 receives information concerning the search results from search application 12 and causes advertisements relevant to those results to be displayed to the user at display 26 with the results.

The present invention may be embodied in other specific forms, or performed using other steps, without departing from its spirit or essential characteristics. The described embodiments and methods are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of providing search results from content on a computer network, including the steps of:
performing a search on a query submitted by a user to generate ranked search results;
identifying a group of individuals which said user has chosen to include in a user-defined list;
and, when ranking the search results, consulting group search information connected with previous searches carried out by members of the group.

2. A method as claimed in claim 1 and wherein the group search information includes information about the behavior of members of the group connected with search results of previous searches.

3. A method as claimed in claim 1 and wherein the search results are ranked using weightings derived from the group search information.

4. The method as claimed in claim 3 and wherein the search is performed to generate initial ranked search results, and including the step of re-ranking them using weightings derived from the group search information.

5. The method as claimed in claim 4 and wherein both ranked and re-ranked search results are available to said user.

6. The method as claimed in claim 3 and wherein the search is performed to generate initial ranked search results, the results being ranked using an algorithm which includes the use of weightings derived from the group search information.

7. The method as claimed in claim 1 and including the steps of:
collecting information about the behavior of said user in connection with the search results; and
using the information to update the group search information.

8. The method as claimed in claim 1 and wherein the group includes said user.

9. The method as claimed in claim 1 and wherein the group comprises said user and others belonging to a user-defined online co-user list.

10. The method as claimed in claim 1, and including the steps of:
identifying a plurality of groups of individuals with which said user has chosen to associate; and
consulting the group search information of the plurality of groups when ranking the search results.

11. The method as claimed in claim 10 and wherein at least one of said plurality of groups comprises said user and others belonging to a user-defined online co-user list.

12. The method as claimed in claim 10 and wherein at least one of said plurality of groups is an online community whose members have a common interest and with which said user has chosen to associate.

13. The method as claimed in claim 1 and including the steps of:
identifying at least one related group which does not include said user and which does include an individual who is a member of the group of individuals which said user has chosen to include in the user-defined list; and
consulting the group search information of the at least one related group when ranking the search results.

14. The method as claimed in claim 13 and wherein weightings used in ranking the search results give more significance to the group search information of the group of individuals which said user has chosen to include in a user-defined list than the group search information of said at least one related group.

15. The method as claimed in claim 1 wherein the group search information represents a combination of search information associated with the individuals.

16. The method as claimed in claim 1 and including selecting advertisements for display to the user based on the ranked search results.

17. An apparatus for providing search results from content on a computer network, comprising: a search application for generating search results in response to a user query; a store listing a group of individuals including said user, the individuals having been chosen by the user to be included in the group; a database holding group search information connected with previous searches carried out by members of the group; and ranking means operative to receive said group search information from said database and to rank the search results by applying weightings derived from said information.

18. Apparatus as claimed in claim 17 and including means for collecting information concerning user behavior in connection with the search results and means for updating said database using said information.

19. Apparatus as claimed in claim 17 and wherein the group comprises said user and others belonging to a user-defined online co-user list.
